(19) United States
(12) Patent Application Publication
(10) Pub. No.: US 2024/0320031 A1
(43) Pub. Date: Sep. 26, 2024

(54) COMPUTER, CONTROL METHOD, AND COMPUTER READABLE MEDIUM

(71) Applicant: Mitsubishi Electric Corporation, Tokyo (JP)

(72) Inventors: Toshikazu KATO, Tokyo (JP); Hitoshi YAMAMOTO, Tokyo (JP); Masataka IEDA, Tokyo (JP)

(73) Assignee: Mitsubishi Electric Corporation, Tokyo (JP)

(21) Appl. No.: 18/734,003

(22) Filed: Jun. 5, 2024

Related U.S. Application Data
(63) Continuation of application No. PCT/JP2022/002931, filed on Jan. 26, 2022.

(51) Int. Cl. G06F 9/48

(52) U.S. Cl. CPC G06F 9/485; G06F 9/4831; G06F 2209/482

(57) ABSTRACT

A context switching processing unit (112) performs context switching using a stack frame indicated by a stack pointer value. When a second program is being executed for more than a predetermined time after a first program calls the second program by a function call and the first program suspends execution, an execution state restoration preparation unit (109) constructs in a stack area for the first program, a first program stack frame which is a stack frame for restoring an execution state of the first program before the execution suspension, in accordance with a configuration of a stack frame used by the context switching processing unit (112). Further, the execution state restoration preparation unit (109) sets to the stack pointer value, a head address value of the first program stack frame.

### CROSS REFERENCE TO RELATED APPLICATIONS

This application is a Continuation of PCT International Application No. PCT/JP2022/002931 filed on Jan. 26, 2022, which is hereby expressly incorporated by reference into the present application.

### TECHNICAL FIELD

The present disclosure relates to context switching performed by a computer.

### BACKGROUND ART

A computer that implements an embedded system such as an industrial device needs to implement control according to a property of an application destination. In order to promptly cope with diversified individual needs, it is conceivable to install in the computer, a base program that provides a common function and an add-on program that provides an extended functionality.

When the add-on program developed by a developer that is different from that of the base program is installed in the computer, an event (hereinafter, such an event is referred to as an “overrun”) may occur in which the add-on program is executed for more than a predetermined upper limit of an execution time due to a defect or the like.

If the overrun occurs, control may not return to the base program and the computer may run out of control.

When the add-on program is executed by a function call as a part of processing of an existing task, the base program to be executed after the add-on program is not executed if the task is forcibly terminated when the overrun occurs. Therefore, in a case where the task is forcibly terminated, the computer may also run out of control.

Thereby, an interrupt handler or another task that has detected the overrun of the add-on program needs to restore an execution state of the base program at an execution point immediately before the function call of the add-on program, to invalidate the add-on program, and to execute subsequent processing of the base program based on the restored execution state.

There is a technique described in Non-Patent Literature 1 as a technique relating to such control.

As described in Non-Patent Literature 1, the standard library of the C language provides a setjmp function and a longjmp function.

An execution state of any execution point can be saved by executing the setjmp function. Further, the saved execution state can be restored and processing after the execution point can be executed by executing the longjmp function.

### CITATION LIST

### Patent Literature

Non-Patent Literature 1: ISO/IEC 9899:2011 Information technology—Programming languages—C

### SUMMARY OF INVENTION

### Technical Problem

The technique described in Non-Patent Literature 1 has a problem that it is not possible to continue operation of the computer when the longjmp function is executed from an execution context (an interrupt handler or a task) that is different from a task that has executed the setjmp function in a multitask environment. When the longjmp function is executed, the execution state is immediately restored. As a result, inconsistency with a context switching process or task scheduling occurs, and it is not possible to continue the operation of the computer.

Specifically, the inconsistency occurs in task management data for the context switching process. Further, since context switching that is different from a framework of the task scheduling is performed, priority reversal may occur between tasks depending on execution situations of the tasks. That is, even when execution of another program whose priority is higher than that of the base program is scheduled, the execution state of the base program is immediately restored by the execution of the longjmp function, and the inconsistency with the task scheduling occurs.

One of main purposes of the present disclosure is to solve a problem such as above. Specifically, the present disclosure mainly aims to enable operation of a computer to continue even when an overrun occurs in a program executed by a function call.

### Solution to Problem

A computer according to the present disclosure includes:

a context switching processing unit to perform context switching using a stack frame indicated by a stack pointer value;

a stack frame construction unit, when a second program is being executed for more than a predetermined time after a first program calls the second program by a function call and the first program suspends execution, to construct in a stack area for the first program, a first program stack frame which is a stack frame for restoring an execution state of the first program before the execution suspension, in accordance with a configuration of a stack frame used by the context switching processing unit; and

a stack pointer value setting unit to set to the stack pointer value, a head address value of the first program stack frame.

### Advantageous Effects of Invention

According to the present disclosure, it is possible to continue operation of a computer even when an overrun occurs in a second program executed by a function call.

### BRIEF DESCRIPTION OF DRAWINGS

FIG. 1 is a diagram illustrating a hardware configuration example of a computer according to Embodiment 1.

FIG. 2 is a diagram illustrating a functional configuration example of the computer according to Embodiment 1.

FIG. 3 is a diagram illustrating an outline of operation of the computer according to Embodiment 1.

FIG. 4 is a flowchart illustrating details of an execution state saving process according to Embodiment 1.

FIG. 5 is a flowchart illustrating details of an execution state restoration preparation process according to Embodiment 1.

### DESCRIPTION OF EMBODIMENTS

Embodiments will be described hereinafter with reference to the drawings. In the following description of the embodiments and the drawings, portions denoted by the same reference signs indicate the same or corresponding portions.

### Embodiment 1

### Description of Configuration

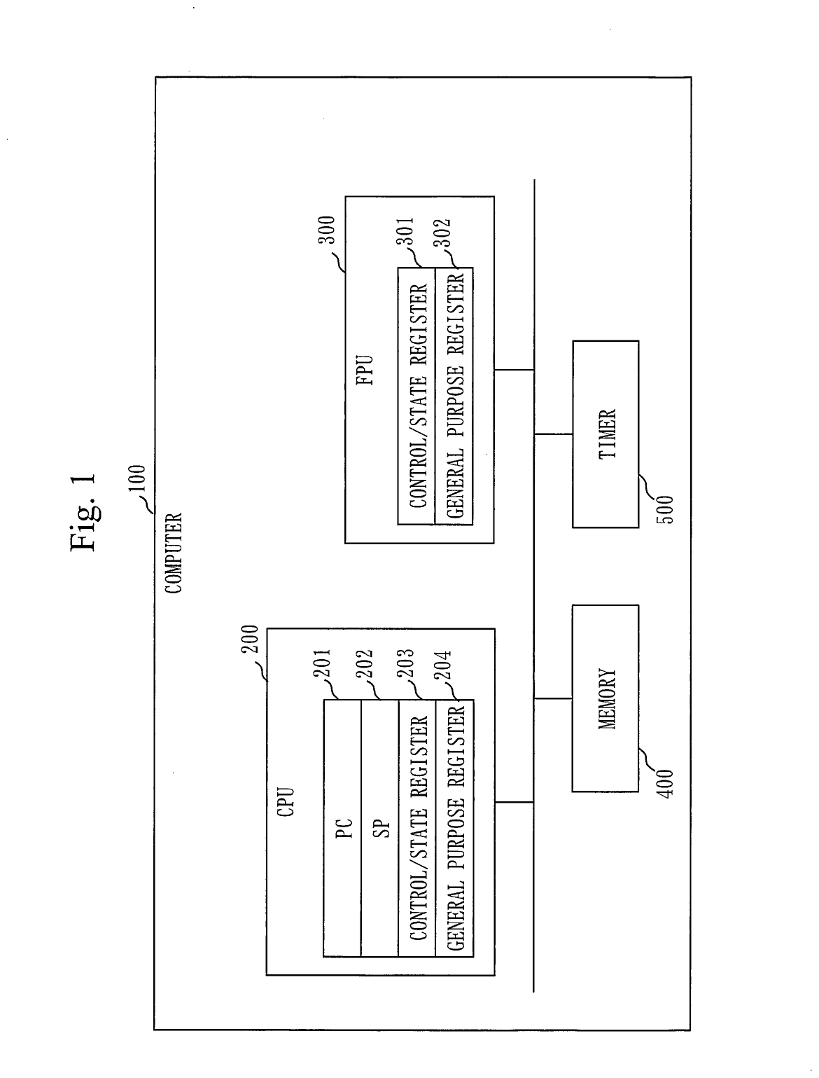

FIG. 1 illustrates a hardware configuration example of a computer 100 according to the present embodiment.

A processing procedure of the computer 100 is equivalent to a control method. Further, a program that implements processing of the computer 100 is equivalent to a control program.

As illustrated in FIG. 1, the computer 100 includes a CPU 200, an FPU 300, a memory 400, and a timer 500.

Each of the CPU 200, the FPU 300, the memory 400, and the timer 500 will be described below.

The CPU 200 is a Central Processing Unit. The CPU 200 is an example of a processor.

The CPU 200 calls a program stored in the memory 400 and executes the program. Specifically, the CPU 200 executes the above described base program and add-on program. As described above, the base program is a program that provides a common function. Furter, the add-on program is a program that provides an extended functionality.

In the drawings, the base program may be simply referred to as “base”. Similarly, the add-on program may be simply referred to as “add-on”.

Further, the CPU 200 executes a high priority program to be described below.

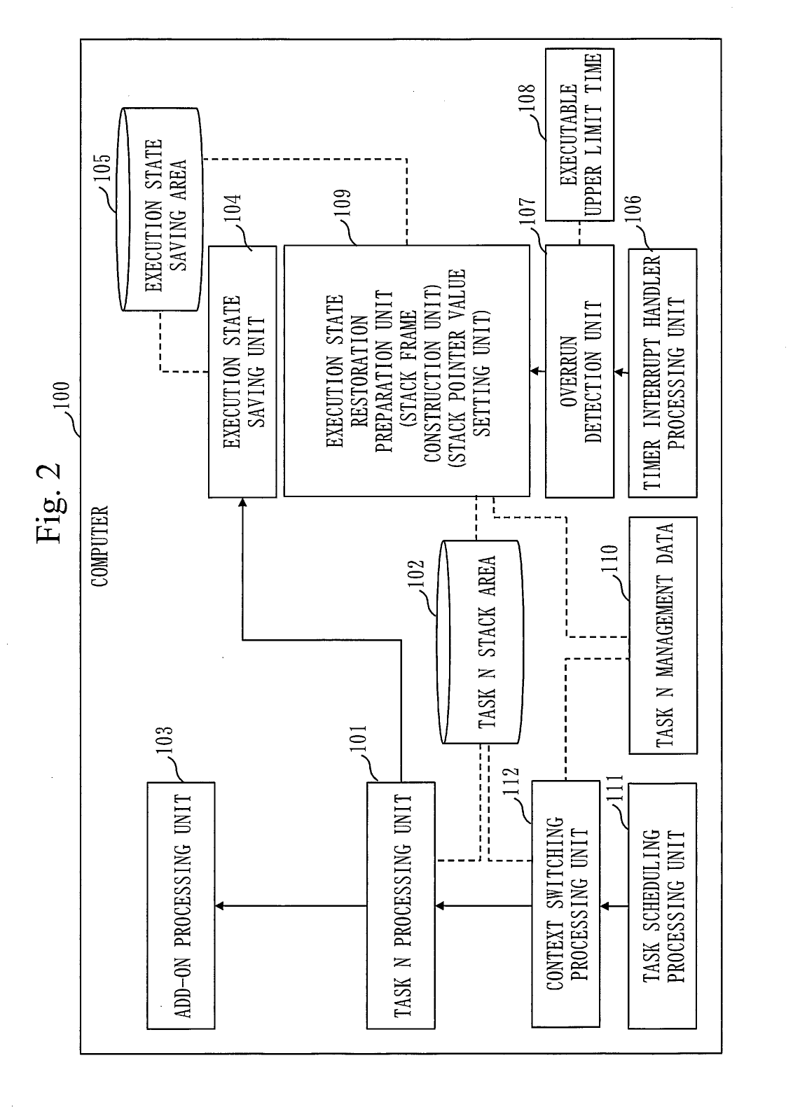

Furthermore, the CPU 200 executes programs that implement functional configuration elements of the computer 100 to be described below. More specifically, the CPU 200 executes the programs that implement the elements each of whose end is “unit” such as a task N processing unit 101, among the elements illustrated in FIG. 2.

Further, the CPU 200 may cause the FPU 300 to perform a floating point operation.

Further, the CPU 200 performs time management by controlling the timer 500.

The CPU 200 includes a PC 201, an SP 202, a control/state register 203, and a general purpose register 204.

The PC 201 is a program counter. The PC 201 holds an address position of a command to be executed.

The SP 202 is a stack pointer. The SP 202 indicates a head address of a stack area.

The control/state register 203 holds a setting and a state for execution of a program on the CPU 200. The control/state register 203 may be separated into a control register and a state register.

The general purpose register 204 holds information such as an operation result and a reference address for the execution of the program.

The FPU 300 is a Floating Point Unit. The FPU 300 performs the floating point operation.

The FPU 300 includes a control/state register 301 and a general purpose register 302.

The control/state register 301 holds a setting and a state for the floating point operation in the FPU 300. The control/state register 301 may be separated into a control register and a state register.

The general purpose register 302 holds an operation result and the like of the floating point operation.

The memory 400 includes a main storage device and an auxiliary storage device.

The memory 400 stores a code and data of a program. As described above, the memory 400 stores the programs that implement the functional configuration elements (the elements each of whose end is “unit” in FIG. 2) of the computer 100. Further, the memory 400 stores the base program, the add-on program, and the high priority program.

Furthermore, there is an execution state saving area 105 of FIG. 2 to be described below in the memory 400.

There are also stack areas in the memory 400. In the stack areas, there are a stack area for a task M, a stack area for a task N, and a stack area for a timer interrupt handler, to be described below.

The timer 500 has a function of performing time measurement.

Further, the timer 500 has a function of generating an interrupt to the CPU 200 at any time period.

Here, configurations of the tasks and the interrupt handler according to the present embodiment will be described.

In the present embodiment, the CPU 200 executes programs in the task M, the task N, and the timer interrupt handler.

The CPU 200 executes a timer interrupt handler process, an overrun detection process, an execution state restoration preparation process, a context switching process, a task scheduling process, and the like, in the timer interrupt handler. That is, the CPU 200 executes the programs that implement the functional configuration elements (the elements each of whose end is “unit” in FIG. 2) of the computer 100, in the timer interrupt handler.

The CPU 200 may execute a program other than the programs that implement the functional configuration elements (the elements each of whose end is “unit” in FIG. 2) of the computer 100, in the timer interrupt handler. However, as described below, the CPU 200 executes the base program and the add-on program in the task N.

The CPU 200 executes the base program and the add-on program in the task N.

Further, the CPU 200 may execute in the task M, the high priority program whose priority is higher than those of the base program and the add-on program.

In the present embodiment, the base program calls the add-on program by a function call. Further, the add-on program may be executed for more than a predetermined time (an overrun may occur).

The base program is equivalent to a first program. Further, the add-on program is equivalent to a second program. Furthermore, the high priority program is equivalent to a third program.

The present embodiment mainly aims to restore an execution state of the base program in order not to suspend operation of the computer 100 in a case where the overrun occurs in the add-on program.

Accordingly, the following description will be given mainly about operation of restoring the execution state of the base program in the case where the overrun occurs in the add-on program.

Therefore, description of the execution of the programs in the timer interrupt handler, the execution of the program other than the base program and the add-on program in the task N, and the execution of the high priority program in the task M will be given below as far as a restoration process for the execution state of the base program is concerned in the case where the overrun occurs in the add-on program. Further, the same applies to restoration of the execution state of the base program in a case where the overrun does not occur in the add-on program.

FIG. 2 illustrates a functional configuration example of the computer 100 according to the present embodiment.

FIG. 2 illustrates the functional configuration elements for restoring the execution state of the base program in the case where the overrun occurs in the add-on program.

Although the computer 100 also includes a functional configuration element that controls execution of a program in the timer interrupt handler and execution of a program in the task M, its illustration is omitted in FIG. 2.

The task N processing unit 101 performs control of the task N.

When the base program suspends the execution by the function call of the add-on program, the task N processing unit 101 calls an execution state saving unit 104 to be described below.

A task N stack area 102 is in the memory 400 and is in the stack area used by the task N. The task N stack area 102 is used to construct a stack frame for restoring the execution state of the base program.

An add-on processing unit 103 controls the execution of the add-on program.

When the execution state saving unit 104 is called by the task N processing unit 101, the execution state saving unit 104 saves in the execution state saving area 105, the execution state of the base program before the execution suspension.

The execution state saved in the execution state saving area 105 by the execution state saving unit 104 includes a value of the control/state register 203 and a value of the general purpose register 204 of the CPU 200. Further, the execution state saved in the execution state saving area 105 by the execution state saving unit 104 may include a value of the control/state register 301 and a value of the general purpose register 302 of the FPU 300.

The execution state saving area 105 is an area in the memory 400, for saving the execution state of the base program before the execution suspension.

The execution state saving area 105 is an area that is statically secured (whose position can be specified).

The execution state saving area 105 is an area different from the task N stack area 102.

A timer interrupt handler processing unit 106 is an interrupt handler activated by a timer interrupt. The timer interrupt handler processing unit 106 calls an overrun detection unit 107 while the add-on program is running.

The overrun detection unit 107 measures an execution time of the add-on program. Then, the overrun detection unit 107 determines the occurrence of the overrun by comparing the execution time of the add-on program with an executable upper limit time 108.

The executable upper limit time 108 is an upper limit of the execution time of the add-on program. When the execution time of the add-on program exceeds the executable upper limit time 108, the overrun detection unit 107 determines that the overrun has occurred.

When the overrun of the add-on program has occurred, an execution state restoration preparation unit 109 constructs the stack frame for restoring the execution state of the base program before the execution suspension.

In the following, the stack frame for restoring the execution state of the base program before the execution suspension is referred to as a base program stack frame. The base frame stack frame is equivalent to a first program stack frame.

The execution state restoration preparation unit 109 constructs the base program stack frame in the task N stack area 102, using the execution state of the base program before the execution suspension saved in the execution state saving area 105 by the execution state saving unit 104.

Further, the execution state restoration preparation unit 109 constructs the base program stack frame in accordance with a configuration of a stack frame used by a context switching processing unit 112 to be described below.

Furthermore, the execution state restoration preparation unit 109 sets a head address value of the base program stack frame, to a stack pointer value refereed to when the context switching processing unit 112 resumes the task N. The stack pointer value refereed to when the context switching processing unit 112 resumes the task Nis written in task N management data 110. Therefore, the execution state restoration preparation unit 109 overwrites the stack pointer value in the task N management data 110 with the head address value of the base program stack frame.

The execution state restoration preparation unit 109 is equivalent to a stack frame construction unit and a stack pointer value setting unit. Further, processes performed by the execution state restoration preparation unit 109 are equivalent to a stack frame construction process and a stack pointer value setting process.

The stack pointer value refereed to when the context switching processing unit 112 resumes the task N is written in the task N management data 110. Further, an execution state and priority of the task N may be written in the task N management data 110.

A task scheduling processing unit 111 selects a task to be executed next by the CPU 200, based on an execution state and priority of the task.

The task scheduling processing unit 111 is executed when a system call is called from the task or after termination of the interrupt handler.

The context switching processing unit 112 performs the context switching process, using the stack frame indicated by the stack pointer value.

When the task N is scheduled after the overrun has occurred in the add-on program, the context switching processing unit 112 refers to the stack pointer value written in the task N management data 110. Then, the context switching processing unit 112 restores the execution state of the base program, using the stack frame constructed in the task N stack area 102 based on the stack pointer value.

### Description of Operation

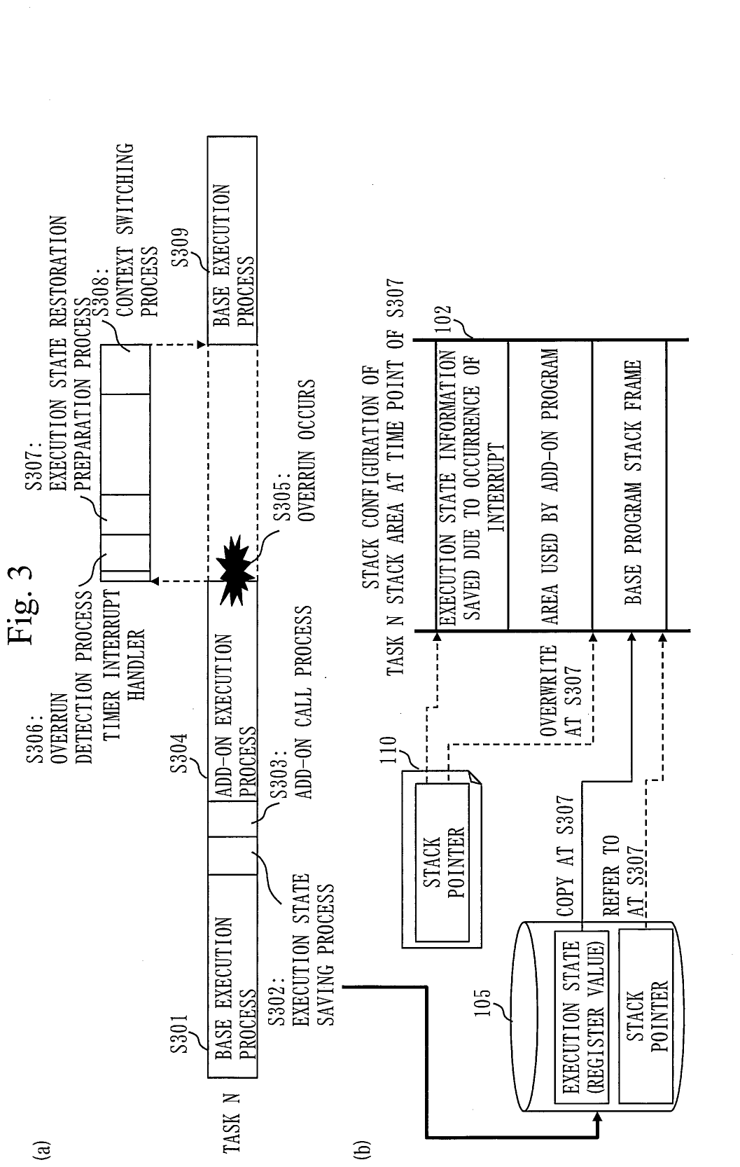

First, an outline of the operation of the computer 100 according to the present embodiment will be described with reference to FIG. 3.
(a) of FIG. 3 illustrates processes executed in the timer interrupt handler and the task N in chronological order. In (a) of FIG. 3, it is assumed that time elapses from left to right.
(b) of FIG. 3 illustrate a stack configuration of the task N stack area 102 at a time point immediately after the execution state restoration preparation process (S307) in (a) of FIG. 3 is executed. At the time point immediately after the execution state restoration preparation process (S307) is executed, there are “execution state information saved due to occurrence of interrupt”, “area used by add-on program”, and “base program stack frame” in the task N stack area 102.

“Area used by add-on program” is a part of the task N stack area 102 used for the execution of the add-on program.

“Execution state information saved due to occurrence of interrupt” is execution state information of the task N saved in the task N stack area 102 when the timer interrupt handler is activated due to the occurrence of the timer interrupt. When “execution state information saved due to occurrence of interrupt” is saved in the task N stack area 102, the stack pointer value in the task N management data 110 is updated with the head address value of “execution state information saved due to occurrence of interrupt”.

In (a) of FIG. 3, the base program is being executed in the task N by the task N processing unit 101 (S301).

Next, in the task N, the task N processing unit 101 calls the execution state saving unit 104 immediately before the base program calls the add-on program by the function call (S303). Then, the execution state saving unit 104 saves the execution state of the base program in the execution state saving area 105 (S302).

The execution state saving unit 104 saves in the execution state saving area 105, for example, a value of the control/state register 203, a value of the general purpose register 204, a value of the control/state register 301, a value of the general purpose register 302, or the like, as the execution state.

Further, the execution state saving unit 104 saves the stack pointer in the execution state saving area 105 (S302). The stack pointer saved in the execution state saving area 105 indicates the head address value of the task N stack area 102 at a current time point.

When the base program calls the add-on program by the function call (S303), the task N processing unit 101 suspends the execution of the base program and calls the add-on processing unit 103.

The add-on processing unit 103 executes the add-on program (S304).

Further, the task N processing unit 101 notifies the timer interrupt handler processing unit 106 that the execution of the add-on program has started. The timer interrupt handler processing unit 106 calls the overrun detection unit 107.

If the overrun occurs in the add-on program due to a defect or the like (S305), the overrun detection unit 107 detects the overrun of the add-on program in the timer interrupt handler (S306). The overrun detection unit 107 calls the execution state restoration preparation unit 109.

Next, the execution state restoration preparation unit 109 performs preparation for restoring the execution state in the timer interrupt handler (S307). Specifically, as illustrated in (b) of FIG. 3, the execution state restoration preparation unit 109 refers to the stack pointer saved in the execution state saving area 105 to specify the head address value of the task N stack area 102 immediately before the execution of the add-on program. Further, the execution state restoration preparation unit 109 obtains from the execution state saving area 105, the execution state of the base program. Then, the execution state restoration preparation unit 109 constructs on a part above the specified head address (a stack extension direction) in the task N stack area 102, the base program stack frame that contains the execution state obtained from the execution state saving area 105.

Furthermore, the execution state restoration preparation unit 109 overwrites the stack pointer in the task N management data 110 with the head address value of the base program stack frame. The stack pointer in the task N management data 110 before being overwritten indicates the head address of the execution state information of the task N during executing the overrun add-on program that has been suspended due to the activation of the timer interrupt handler.

At the time point of S307, only the preparation for restoring the execution state of the base program is performed, and the restoration of the execution state is not performed.

After that, in the timer interrupt handler, the context switching process is performed by the context switching processing unit 112 at a timing of task scheduling (S308). That is, at the time point when the task scheduling processing unit 111 schedules resumption of the execution of the base program in the task N, the context switching processing unit 112 performs the context switching process for the base program.

In a case where the execution is scheduled first in the task M of the high priority program whose priority is higher than that of the base program in the task N, the context switching process for the base program is performed at the time point when the resumption of the execution of the base program is scheduled after completion of the execution of the high priority program in the task M.

In the context switching process for the base program, the context switching processing unit 112 refers to the stack pointer value written in the task N management data 110. Then, the context switching processing unit 112 restores the execution state of the base program, using the stack frame constructed in the task N stack area 102 based on the stack pointer value.

Next, details of an execution state saving process (S302) and the execution state restoration preparation process (S307) of FIG. 3 will be described.

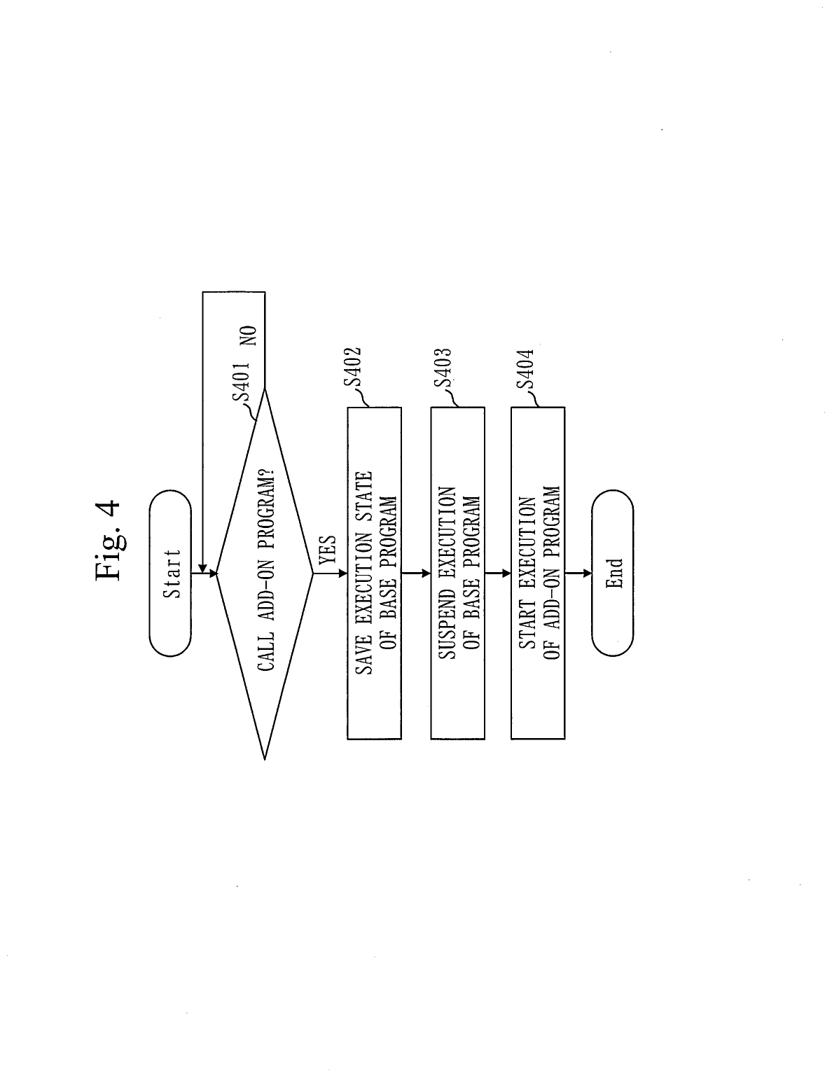

FIG. 4 is a flowchart illustrating details of the execution state saving process (S302).

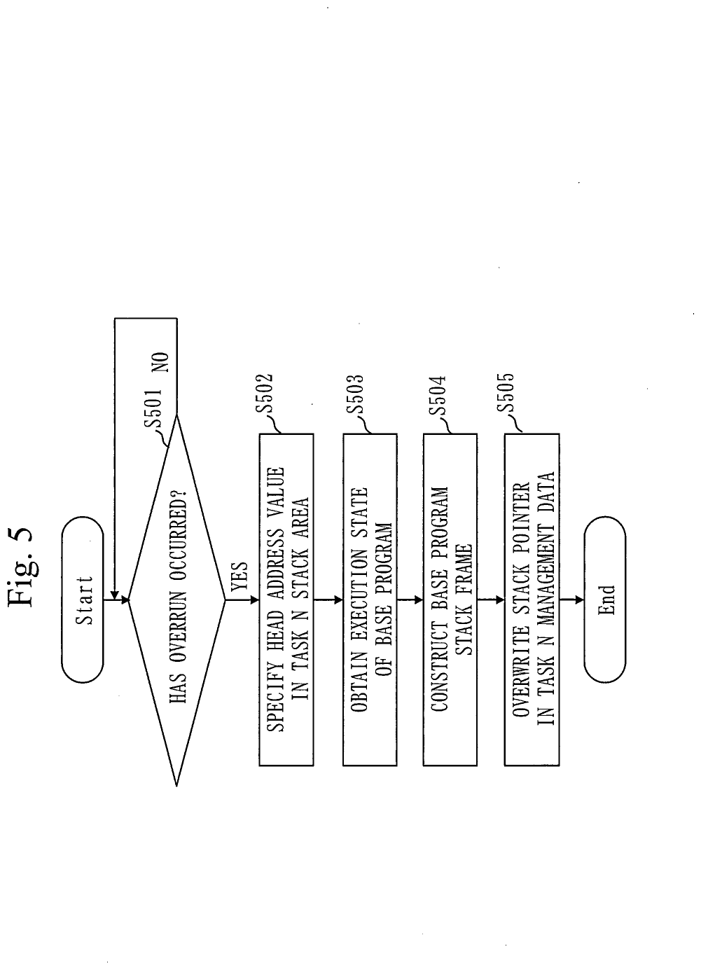

FIG. 5 is a flowchart illustrating details of the execution state restoration preparation process (S307).

First, the details of the execution state saving process (S302) will be described with reference to FIG. 4.

In step S401, the task N processing unit 101 determines whether or not the call of the add-on program by the function call has occurred during the execution of the base program.

When the call of the add-on program by the function call has occurred (YES in step S401), the task N processing unit 101 calls the execution state saving unit 104 and the process proceeds to step S402.

In step S402, the execution state saving unit 104 stores in the execution state saving area 105, the execution state and the stack pointer of the base program before the suspension. As described above, the execution state saved in the execution state saving area 105 by the execution state saving unit 104 includes, for example, a value of the control/state register 203, a value of the general purpose register 204, a value of the control/state register 301 of the FPU 300, and a value of the general purpose register 302 of the FPU 300.

Further, the stack pointer indicates the head address value at a current time point in the task N stack area 102.

Next, in step S403, the task N processing unit 101 suspends the execution of the base program.

Further, in step S404, the task N processing unit 101 calls the add-on processing unit 103, and the add-on processing unit 103 starts the execution of the add-on program.

Next, the details of the execution state restoration preparation process (S307) will be described with reference to FIG. 5.

When the overrun detection unit 107 determines that the overrun has occurred in the add-on program (YES in step S501), the execution state restoration preparation unit 109 is called by the overrun detection unit 107.

Then, in step S502, the execution state restoration preparation unit 109 refers to the stack pointer saved in the execution state saving area 105 to specify the head address value in the task N stack area 102 immediately before the execution of the add-on program.

Next, in step S503, the execution state restoration preparation unit 109 obtains from the execution state saving area 105, the execution state before the suspension of the base program.

Next, in step S504, the execution state restoration preparation unit 109 constructs on the part above the head address specified in step S502 (the stack extension direction) in the task N stack area 102, the base program stack frame that contains the execution state obtained in step S503.

Next, in step S505, the execution state restoration preparation unit 109 overwrites the stack pointer in the task N management data 110 with the head address value of the base program stack frame constructed in step S504.

### Description of Effects of Embodiment

The present embodiment proceeds only until preparation (construction of a stack frame) for restoring the execution state instead of immediately performing a restoration process for an execution state, when an overrun occurs. Then, the present embodiment restores the execution state of a base program at a timing of task scheduling.

Therefore, according to the present embodiment, consistency can be achieved between the restoration process for the execution state, and a context switching process and the task scheduling, and it is possible to continue operation of a computer.

The processing procedure described in the present embodiment is an example.

Therefore, only a part of the processing procedure described in the present embodiment may be implemented.

Alternatively, at least a part of the processing procedure described in the present embodiment and a processing procedure that has not been described in the present embodiment may be implemented in combination.

Alternatively, the configurations and the processing procedure described in the present embodiment may be modified as necessary.

### Supplementary Description of Hardware Configuration

Finally, a supplementary description of the hardware configuration of the computer 100 will be given.

Each of the CPU 200 and the FPU 300 is an Integrated Circuit (IC) that performs processing.

The memory 400 is a Random Access Memory (RAM), a Read Only Memory (ROM), a flash memory, a Hard Disk Drive (HDD), or the like.

Further, the memory 400 also stores an Operating System (OS).

Then, at least a part of the OS is executed by the CPU 200.

While executing at least the part of the OS, the CPU 200 executes programs that implement functions of the task N processing unit 101, the add-on processing unit 103, the execution state saving unit 104, the timer interrupt handler processing unit 106, the overrun detection unit 107, the execution state restoration preparation unit 109, the task scheduling processing unit 111, and the context switching processing unit 112.

By the CPU 200 executing the OS, task management, memory management, file management, communication control, and the like are performed.

Further, at least one of information, data, a signal value, and a variable value that indicate results of processing of the task N processing unit 101, the add-on processing unit 103, the execution state saving unit 104, the timer interrupt handler processing unit 106, the overrun detection unit 107, the execution state restoration preparation unit 109, the task scheduling processing unit 111, and the context switching processing unit 112 is stored in at least one of the memory 400, the control/state register 203, the general purpose register 204, the control/state register 301, and the general purpose register 302.

Further, the programs that implement the functions of the task N processing unit 101, the add-on processing unit 103, the execution state saving unit 104, the timer interrupt handler processing unit 106, the overrun detection unit 107, the execution state restoration preparation unit 109, the task scheduling processing unit 111, and the context switching processing unit 112 may be stored in a portable recording medium such as a magnetic disk, a flexible disk, an optical disc, a compact disc, a Blu-ray (registered trademark) disc, or a DVD. Then, the portable recording medium storing the programs that implement the functions of the task N processing unit 101, the add-on processing unit 103, the execution state saving unit 104, the timer interrupt handler processing unit 106, the overrun detection unit 107, the execution state restoration preparation unit 109, the task scheduling processing unit 111, and the context switching processing unit 112 may be distributed.

Further, the “unit” of at least one of the task N processing unit 101, the add-on processing unit 103, the execution state saving unit 104, the timer interrupt handler processing unit 106, the overrun detection unit 107, the execution state restoration preparation unit 109, the task scheduling processing unit 111, and the context switching processing unit 112 may be read as a “circuit”, “step”, “procedure”, “process”, or “circuitry”.

Further, at least one of the task N processing unit 101, the add-on processing unit 103, the execution state saving unit 104, the timer interrupt handler processing unit 106, the overrun detection unit 107, the execution state restoration preparation unit 109, the task scheduling processing unit 111, and the context switching processing unit 112 may be implemented by a processing circuit. The processing circuit is, for example, a logic Integrated Circuit (IC), a Gate Array (GA), an Application Specific Integrated Circuit (ASIC), or a Field-Programmable Gate Array (FPGA).

In the present description, a superordinate concept of the processor and the processing circuit is referred to as “processing circuitry”.

That is, each of the processor and the processing circuit is a specific example of the “processing circuitry”.

### REFERENCE SIGNS LIST

100: computer; 101: task N processing unit; 102: task N stack area; 103: add-on processing unit; 104: execution state saving unit; 105: execution state saving area; 106: timer interrupt handler processing unit; 107: overrun detection unit; 108: executable upper limit time; 109: execution state restoration preparation unit; 110: task N management data; 111: task scheduling processing unit; 112: context switching processing unit; 200: CPU; 201: PC; 202: SP; 203: control/state register; 204: general purpose register; 300: FPU; 301: control/state register; 302: general purpose register; 400: memory; 500: timer.

1. A computer comprising:
processing circuitry:
to perform context switching, using a stack frame indicated by a stack pointer value;
when a second program is being executed for more than a predetermined time after a first program calls the second program by a function call and the first program suspends execution, to construct in a stack area for the first program, a first program stack frame which is a stack frame for restoring an execution state of the first program before the execution suspension, in accordance with a configuration of a used stack frame; and
to set to the stack pointer value, a head address value of the first program stack frame.

2. The computer according to claim 1, wherein
the processing circuitry refers to the stack pointer value at a time point when resumption of the execution of the first program is scheduled, and restores the execution state of the first program before the execution suspension, using the first program stack frame, based on the head address value of the first program stack frame set to the stack pointer value.

3. The computer according to claim 2, wherein
when execution of a third program whose priority is higher than that of the first program is scheduled before the resumption of the execution of the first program, the processing circuitry restores the execution state of the first program before the execution suspension at the time point when the resumption of the execution of the first program is scheduled after the execution of the third program has completed.

4. The computer according to claim 1, wherein
the processing circuitry saves in a storage area other than the stack area of the first program, the execution state of the first program before the execution suspension, and
constructs the first program stack frame in the stack area for the first program, using the execution state of the first program before the execution suspension saved in the storage area.

5. The computer according to claim 4, wherein
the processing circuitry saves in the storage area, at least one of: a value of the first program before the execution suspension in a control register included in the computer; a value of the first program before the execution suspension in a state register included in the computer; and a value of the first program before the execution suspension in a general purpose register included in the computer, as at least a part of the execution state of the first program before the execution suspension.

6. A control method comprising:
by a processor included in a computer that performs a context switching process using a stack frame indicated by a stack pointer value, when a second program is being executed for more than a predetermined time after a first program calls the second program by a function call and the first program suspends execution, constructing in a stack area for the first program, a first program stack frame which is a stack frame for restoring an execution state of the first program before the execution suspension, in accordance with a configuration of a stack frame used by the context switching process; and
by the processor, setting to the stack pointer value, a head address value of the first program stack frame.

7. A non-transitory computer readable medium storing a control program for causing a computer to execute:
a context switching process to perform context switching using a stack frame indicated by a stack pointer value;
a stack frame construction process, when a second program is being executed for more than a predetermined time after a first program calls the second program by a function call and the first program suspends execution, to construct in a stack area for the first program, a first program stack frame which is a stack frame for restoring an execution state of the first program before the execution suspension, in accordance with a configuration of a stack frame used by the context switching process; and
a stack pointer value setting process to set to the stack pointer value, a head address value of the first program stack frame.
